(19) United States
(12) Patent Application Publication
(10) Pub. No.: US 2026/0100135 A1
(43) Pub. Date: Apr. 9, 2026

(54) StudyFilm Focus Features

(71) Applicant: 2hr Learning, Inc., Austin, TX (US)

(72) Inventors: Pedro Ricardo Gomes Dias, Hong Kong (CN); Zoltan Szalontai, Kecskemet (HU); Ishan Tripathi, Noida (IN); Gaurav Shukla, Calgary (CA)

(73) Assignee: 2hr Learning, Inc., Austin, TX (US)

(21) Appl. No.: 19/352,347

(22) Filed: Oct. 7, 2025

Related U.S. Application Data
(60) Provisional application No. 63/704,529, filed on Oct. 7, 2024.
(60) Provisional application No. 63/704,528, filed on Oct. 7, 2024.
(60) Provisional application No. 63/704,530, filed on Oct. 7, 2024.

(51) Int. Cl. G09B 5/02; G06F 3/01; G06V 20/52

(52) U.S. Cl. CPC G09B 5/02; G06F 3/011; G06V 20/52; G06V 2201/02

(57) ABSTRACT

A real-time focus score calculation and visualization system and method for guiding an Artificial Intelligence (AI) Engine to generate a real-time focus score and visualize it for a user are disclosed. The real-time focus score calculation and visualization process involves receiving input data from multiple sources including webcam, screen content, and app usage, and providing the analyzed data to the Artificial Intelligence (AI) Engine to determine the presence, idleness, and focus of the user by utilizing a plurality of multiple machine learning algorithms. The focus score is recalculated every second by the AI Engine to determine the user's current level of engagement and is presented to the user in real-time along with an issue count, current status, or ongoing issue related to the user's current level of engagement, visually color-coded feedback.

### CROSS-REFERENCE TO RELATED APPLICATION(S)

This application claims the benefit under 35 U.S.C. § 119 (c) and 37 C.F.R. § 1.78 of U.S. Provisional Application Nos. 63/704,528, 63/704,529, and 63/704,530, which are incorporated by reference in its entirety.

This application incorporates U.S. application Ser. Nos. 19/177,465, 19/177,471, 19/177,496 by reference in their entireties.

### FIELD OF THE INVENTION

The present invention relates in general to the field of electronics, and more specifically to a system and method for real-time focus score calculation of a user using an online learning platform and presenting the focus score to the user along with the user's current level of engagement and visually color-coded feedback.

### BACKGROUND OF THE INVENTION

In today's learning environment, it's quite hard to monitor and measure whether a student is focusing on the learning content during an online learning session. These problems particularly arise in online learning scenarios, where no tutor is available in front of the student to monitor session engagement. Students get easily distracted during the online learning session or may switch to other apps or browsers during the online learning session. For instance, the user may switch to apps like a calculator or any other AI tool to get help on the questions asked in the online learning session.

Traditional methods usually rely on updates collected every few minutes or hours, which means important moments of distraction or engagement can be missed. These older systems often track one type of data, like how long a student is using a particular app, without considering other factors, like whether the student is physically present or engaged. Further, different educational systems are using various methods for monitoring student focus like simple timers or session trackers that monitor the duration of app usage or screen activity. These systems and methods have limitations that will prevent them from giving feedback based on real-time analysis.

The traditional systems give alerts to the users if they spend too much time on distracting activities but the method typically involves periodic updates which may lag or critical moments of distraction or engagement. Conventional systems mainly depend on less frequent data collection intervals like a few minutes or hours. The feedback provided to the user is provided after a predefined period, say after every 24 hours. In such cases, the user gets to know the problems made by them during the online learning session, after a certain period. These systems are only tracking one type of data like app usage or screen time. Lack of integration of multiple data streams will lead to a lack of comprehensive analysis of student focus.

Another problem that occurs during online learning is the distraction caused by switching between tasks. Many educational platforms don't stop students from switching between apps, which can break their concentration and affect learning. Conventionally, some applications block the user into the applications for a predefined time, i.e., the time till the user finishes the task.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary real-time focus score calculation and visualization system.

FIG. 2 depicts an exemplary real-time focus score calculation and visualization process.

FIG. 3 depicts an exemplary focus score calculation process, which is an embodiment of the real-time focus score calculation and visualization process of FIG. 2.

FIG. 4 depicts an exemplary windows switching cooldown process when a user is working in focus mode on the online learning platform, which is an embodiment of the real-time focus score calculation and visualization process of FIG. 2.

FIG. 5 depicts an exemplary user interface disclosing the use of a browser other than the online learning platform during the online learning session for which the real-time focus score is calculated and presented to the user.

FIG. 6 depicts an exemplary user interface disclosing the use of other applications during the online learning session for which the real-time focus score is calculated and presented to the user.

FIGS. 7-10 depict exemplary user interfaces disclosing the focus score of the user along with the corresponding issue.

FIG. 11 depicts an exemplary user interface showing a focus timer that gets activated when the user enters focus mode.

FIGS. 12 and 13 depict exemplary user interfaces showing the cooldown timer along with a message that educates the user about the negative impacts of switching tasks during the online learning sessions.

FIG. 14 depicts an exemplary network environment in which the real-time focus score calculation and visualization system of FIG. 1 and the real-time focus score calculation and visualization process of FIG. 2 may be practiced.

FIG. 15 depicts an exemplary computer system.

### DETAILED DESCRIPTION

The real-time focus score calculator and visualization system and method set forth herein address technical issues with generating a focus score and visualize it for a user described herein. Conventionally, manual processes were used to generate the focus score and visualize it and were very tedious and time consuming. The present real-time focus score calculator and visualization system and method utilize an automated system that does not merely automate a manual process or use a conventional system in a conventional way. The present real-time focus score calculator and visualization system and method utilize one or more artificial intelligence (AI) engines and integrate programmatic process management to technologically guide and constrain the one or more AI engines to produce the focus score and visualize it for the user in a completely different way than both any manual process and different than normal use of programs and AI engines. Utilizing specially engineered guidance and control to direct an AI system in solving the technical problems presented below, which require a technical solution. The real-time focus score calculator and visualization system and method described below are not simply engaging a computer to carry out conventional mental processes, but rather change how computers (and AI systems, specifically) operate to achieve the generation results that were not previously possible or were substantially inefficient prior to the real-time focus score calculator and visualization system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the focus score specified as produced by the real-time focus score calculator and visualization system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The real-time focus score calculator and visualization system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce the focus score and visualize it for the user, perform quality control to retain or automatically discard outputs that do not meet guidance and constraints, and make the focus score available for use, such as use by computer system applications. In at least one embodiment, the problem to be solved by the integrated programmatic and AI engine real-time focus score calculator and visualization system and method is uniquely and unconventionally decomposed, and AI prompts are used to solve the decomposed problem. Furthermore, the programmatic inputs to the decomposed AI prompts provide guidance to generate the focus score and visualize it for the user

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the real-time focus score calculator and visualization system and method described herein. Thus, the present real-time focus score calculator and visualization system and method described implement an integration of programmatic management over decomposed prompts with engineered AI engine guidance and constraints to affect an improvement in AI, programmatic AI management, and AI integrated with programmatic management technology. The present real-time focus score calculator and visualization system and method allow computer systems to include programmatic management, one or more AI engines, and one or more data sources to generate the focus score and visualize it for the user that previously could not be produced with conventionally prompted AI engines or could only be produced by humans utilizing a completely different, time consuming, and tedious process. The real-time focus score calculator and visualization system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the real-time focus score calculator and visualization systems and methods. For example, use of the term “invention” does not limit or require the referenced certain features to be present in all embodiments of the invention. Use of absolute-type terms, such as “required,” “must,” “only,” “important,” and so on are not limiting of all embodiments of the real-time focus score calculator and visualization systems and methods and not to be construed as limiting of the embodiments of the real-time focus score calculator and visualization systems and methods described above.

A real-time focus score calculator and visualization system and method for guiding an Artificial Intelligence (AI) engine to generate a focus score and visualize it for a user is disclosed. The real-time focus score calculator and visualization system includes an online learning platform that is operatively coupled to a focus score calculation planner. A data collector is integrated into the focus score calculation planner and is configured to collect input data from multiple sources, including, a webcam, screen content, and app usage data. The collected input data is then provided to an analyzer configured to generate the insights. These insights and the generated prompts are provided to the AI engine. In addition to the prompts, the AI engine receives rules and guidelines to generate the desired output response.

Upon receiving the prompts and insights from the AI engine, the current engagement status of the user is detected. The AI engine utilizes multiple machine learning algorithms, including, a presence detection algorithm, a screen change detection algorithm, and an app detection algorithm to detect whether the user is absent or present in front of the webcam, idleness of the user, and whether the user is switching to other applications or browsers while using the online learning platforms.

Upon detection of these engagement statuses, a focus score calculator calculates and presents the focus score to the user along with an issue count, visually color-coded feedback, and the current level of engagement of the user.

The real-time focus score calculation and visualization system enhances user engagement during online learning by continuously tracking focus in real-time through data from multiple sources such as webcam, screen content, and application usage. By utilizing multiple AI algorithms, the real-time focus score calculation and visualization system calculates the focus score, which is further recalculated every second and displayed to the user in the form of color-coded feedback to help users stay aware of their engagement. The real-time focus score calculation and visualization system also discourages distractions through adaptive deterrents like cooldown periods and educational messages when task-switching is detected.

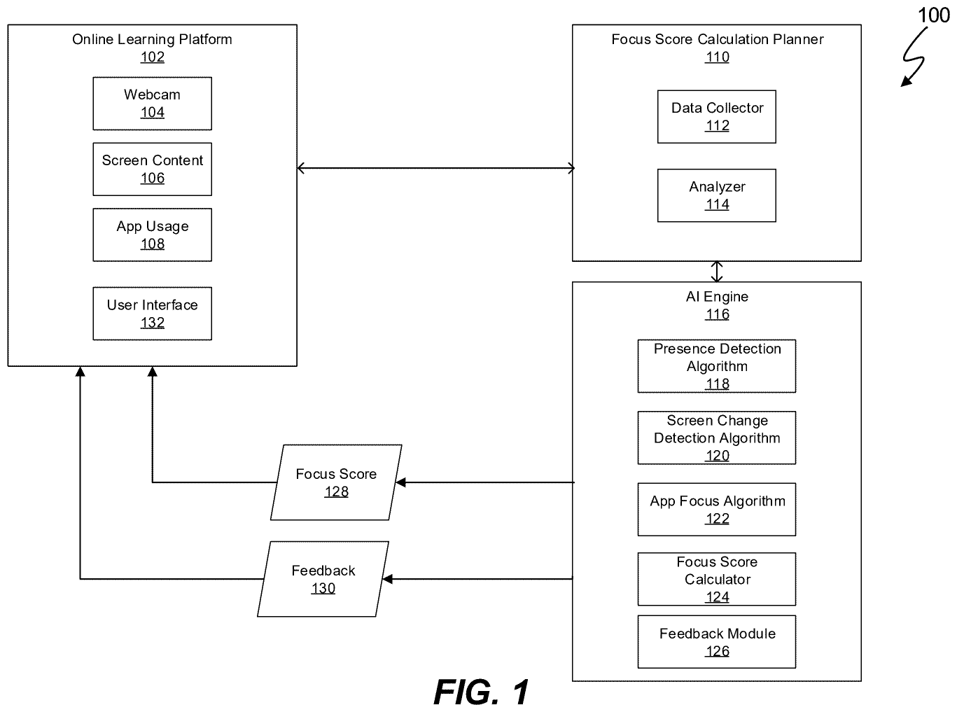

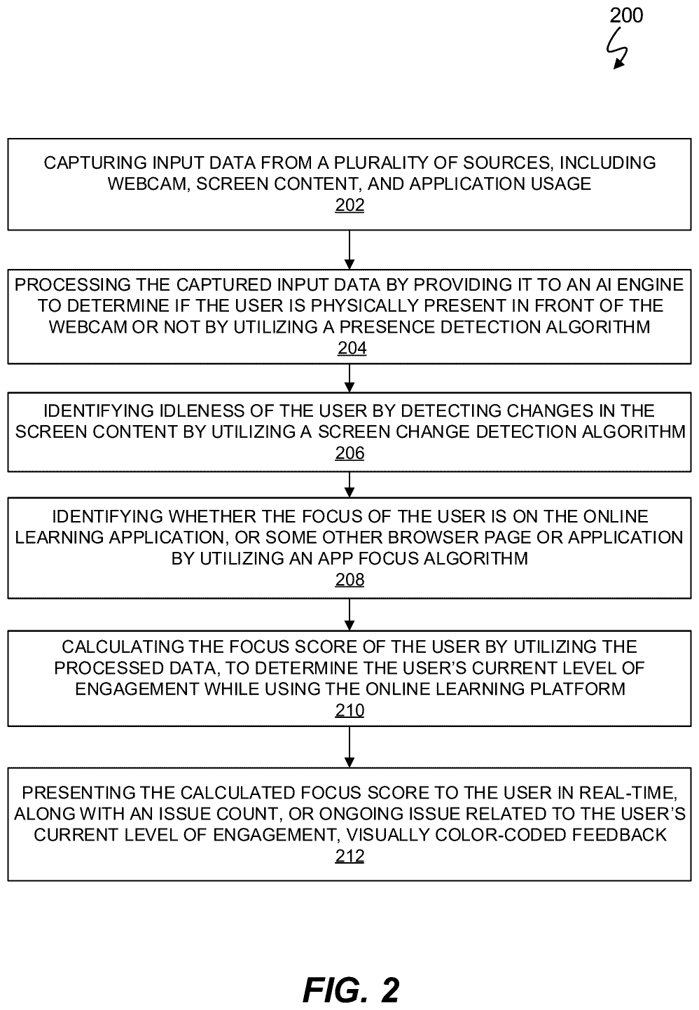

FIG. 1 depicts an exemplary real-time focus score calculation and visualization system 100 to generate and visualize the focus score 128 for a user. FIG. 2 depicts an exemplary real-time focus score calculation and visualization process 200 used by the real-time focus score calculation and visualization system 100.

In operation 202, a data collector 112 captures input data from a plurality of sources including webcam 104, screen content 106, and app usage 108.

The data collector 112 is integrated within a focus score calculation planner 110, which is operatively coupled to the online learning platform 102. The data collector 112 captures input data from multiple sources, including the webcam 104, screen content 106, and app usage 108, in real-time. In one embodiment, the data collector 112 gathers new input data at an interval of 1 second to ensure accurate and up-to-date monitoring of the user's activities.

The data captured from these sources serves different purposes. The webcam 104 data provides user presence detection, which is used to determine if the user is physically present in front of the screen. This is crucial for assessing whether the user is engaged in the online learning session or has stepped away. The screen content 106 is used for detecting idleness by monitoring changes in the screen, such as whether the user is actively interacting with the online learning content or simply letting the online learning session run. Finally, the app usage 108 data tracks whether the user is focused on the online learning platform 102 or has switched to another application or browser window.

In addition to these specific types of input data, the data collector 112 also records the time duration when the user is not focused on the online learning platform 102, and the corresponding video frame. This means that if the user steps away from the webcam 104, remains idle on the screen, or switches to another application, the data collector 112 determines how long the user remains disengaged from the online learning platform 102. This helps calculate the total unfocused time, which is the cumulative time during which the user is not concentrating on the online learning session.

The total unfocused time is the time that is used to measure user's level of distraction or disengagement from the online learning platform 102. This detailed tracking ensures that the online learning platform 102 can provide real-time insights into the user's behavior and take corrective actions, such as displaying visual feedback or triggering a cooldown mechanism when the user's focus drops.

In operation 204, an analyzer 114 receives the input data from the data collector 112. It provides the analyzed data to the AI engine 116 to determine whether the user is physically present in front of the webcam 104 by utilizing a presence detection algorithm 118.

The analyzer 114 is integrated within the focus score calculation planner 110 and receives the input data from the data collector 112. The analyzer 114 analyzes the input data provided by the data collector 112 and generates insights that are used to determine the presence of the user during the online learning session, the idleness status of the user, and the switching of the user from the online learning platform 102 to another application or browser.

Along with the input data captured from the webcam 104, screen content 106, and app usage 108, a prompt generated by a prompt engineer is also provided to the AI engine 116. This prompt serves as a set of instructions or guidelines that help the AI engine 116 process the input data more effectively. The AI engine 116 utilizes the insights generated from the analyzer 114 to generate the result for the prompt.

The determination of the user's physical presence is carried out by analyzing frames captured from the webcam 104. The data collector 112 captures these frames at regular intervals, typically one frame per second, ensuring a steady stream of data for real-time analysis. These frames are then analyzed by the presence detection algorithm 118, which looks for specific indicators such as facial features, body movement, and other visual cues that confirm the user is physically present. If the presence detection algorithm 118 successfully identifies these features, it concludes that the user is present and engaged. However, if the presence detection algorithm 118 does not detect these indicators, it determines that the user is absent, meaning they are not physically present in front of the webcam 104 and likely not attending the online learning session. This absence status of the user indicates the disengagement of the user from the online learning platform 102 during the online learning session, which in turn leads to a decrease in the focus score 128 of the user.

After processing the captured input data, the AI engine 116 generates a response utilizing the presence detection algorithm 118. The generated response is in JSON format, which is a structured and easy-to-interpret data format. The response typically includes a simple true or false result. If the AI engine 116 detects that the user is present and focused, the result will be ‘true,’ indicating positive engagement. On the other hand, if the user is absent or distracted, the result will be ‘false,’ indicating a lack of focus from user's side.

An exemplary prompt provided to the AI engine 116 which utilizes the presence detection algorithm 118 to detect the presence of the user in front of the webcam 104 is given below:

```
“””
You have one purpose: to detect people in photos. I will give you a
photo and you must tell me if there are people in the photo or not. The
photo might have people only partially visible: you may see a hand,
half the face, the back of the head, etc. In those cases, it STILL
COUNTS as people being in the photo.
  Your response should be a valid JSON object with the following key:
    ″personVisible″: ″true″ or ″false″
  I am not rooting for any particular outcome, ALL I want is the
OBJECTIVE TRUTH about whether there is a person in the photo or not -
ACCURACY is ALL THAT MATTERS.
  Example response:
  {
    ″personVisible″: ″false″
  }
“””
```

The prompt generated by the prompt engineer is provided to the AI engine 116 to identify whether the user is present in a given video frame or not, regardless of how much part of the user is visible. For example, the hand or back of the head is counted and is considered as partial presence of the user. The AI engine 116 is asked to provide the output in JSON format, containing a single key, i.e., the presence of the user as either ‘true’ or ‘false’. The main objective of the prompt is to determine the presence or absence of the user. For instance, ‘true’ is indicated for the presence of the user, and ‘false’ is indicated for the absence of the user.

In operation 206, a screen change detection algorithm 120 identifies the idleness of the user by detecting changes in the screen content 106.

The analyzer 114 is integrated within the focus score calculation planner 110 and receives the input data from the data collector 112. The analyzer 114 analyzes the input data provided by the data collector 112 and generates insights that are used to determine the presence of the user during the online learning session, the idleness status of the user, and the switching of the user from the online learning platform 102 to another application or browser.

Along with the input data captured from the webcam 104, screen content 106, and app usage 108, a prompt generated by a prompt engineer is also provided to the AI engine 116. This prompt serves as a set of instructions or guidelines that help the AI engine 116 process the input data more effectively. The AI engine 116 utilizes the insights generated from the analyzer 114 to generate the result for the prompt.

The AI engine 116 utilizes screen change detection algorithm 120 to identify the idleness of the user during the online learning session by utilizing the periodically collected screenshots of the screen content 106 browsed by the user. In this manner, by collecting and analyzing the real-time screenshots of the screen content 106 of the user, the user's activity can be monitored in real-time, and accordingly, focus score 128 can be adjusted.

For identification of the idleness of the user, the data collector 112 captures screenshots of the screen content at regular, predefined intervals of time. These intervals could be set to a few seconds or longer, depending on the level of monitoring required. The goal of capturing these screenshots is to create a visual record of the user's interactions with the online learning platform 102, including the state of the open windows, cursor movement, and the content being viewed.

Next, the screen change detection algorithm 120 compares consecutive screenshots captured by the data collector 112. The screen change detection algorithm 120 is designed to detect changes between the images, such as whether the user has switched windows, moved the cursor, or interacted with the content of the online learning session (e.g., playing a video, typing, or clicking on elements). The screen change detection algorithm 120 tracks and analyzes these changes to understand how actively the user is engaging with the online learning platform 102.

Finally, the AI engine 116 analyzes the degree of changes between the consecutive screenshots. This analysis is based on a predefined threshold value that determine whether the changes are significant enough to indicate active engagement. If the degree of changes, such as window interactions, cursor movement, or content updates falls below this threshold, the AI engine 116 classifies the user as idle. For example, if there is minimal cursor movement or no window interaction over several consecutive screenshots, the AI engine 116 concludes that the user is not actively engaging with the content and has likely become idle. Detecting idleness in this way allows the AI engine 116 to accurately assess the user's level of focus and participation during the online learning session, which helps in calculation of the focus score 128.

An exemplary prompt provided to the AI engine 116 which utilizes the screen change detection algorithm 120 to identify the idleness of the user is given below:

```
“””
You are an expert image analyzer tasked with analyzing if the provided
screenshots are different.
  You must compare the 2 screenshots to determine if there was any
change on the screen between the 2 screenshots.
    Your response should be a valid JSON object with the following key:
      ″different″: ″true″ or ″false″
    Only set ″different″ to ″false″ if the two images are exactly
identical.
    Example response:
    {
      ″different″: ″true″
    }
“””
```

The prompt generated by the prompt engineer is provided to the AI engine 116 to the idleness of the user. For example, the cursor movement, mouse click, or screen scrolling is counted and is considered as user activity and vice versa. The AI engine 116 is asked to provide the output in JSON format, containing a single key, i.e., the idleness detection of the user as either ‘true’ or ‘false’. The main objective of the prompt is to identify the idleness of the user by comparing the consecutive screenshots of the screen content 106. For instance, ‘true’ is indicated for the idleness of the user, and ‘false’ is indicated when the user is not idle and paying attention during the online learning session.

In operation 208, an app focus algorithm 122 identifies whether the focus of the user is on the online learning application 102, or some other browser page or application.

The analyzer 114 is integrated within the focus score calculation planner 110 and receives the input data from the data collector 112. The analyzer 114 analyzes the input data provided by the data collector 112 and generates insights that are used to determine the presence of the user during the online learning session, the idleness status of the user, and the switching of the user from the online learning platform 102 to another application or browser.

Along with the input data captured from the webcam 104, screen content 106, and app usage 108, a prompt generated by a prompt engineer is also provided to the AI engine 116. This prompt serves as a set of instructions or guidelines that help the AI engine 116 process the input data more effectively. The AI engine 116 utilizes the insights generated from the analyzer 114 to generate the result for the prompt.

The AI engine 116 utilizes app focus algorithm 122 to identify the focus of the user during an online learning session. The app focus algorithm 122 monitors the user's activity to determine whether the user is attentive on the online learning platform 102 or using some other application/browser. For instance, the user may use applications like a calculator or any AI tool to answer questions presented to the user during the online learning session in the online learning platform 102.

This focus detection of the user begins with capturing screenshots of the screen content at regular, predefined intervals. These screenshots are taken periodically to provide an image of the user's current screen state at each interval. This ensures that the data collector 112 collects a continuous series of images that represent the user's activities over time.

Once the screenshots are captured, the AI engine 116 utilizes the app focus algorithm 122 to analyze these images. The app focus algorithm 122 identifies the current webpage or application that the user is interacting with based on the content visible in the screenshots. For instance, app focus algorithm 122 detects whether the user is actively viewing or interacting with the online learning platform 102 or if they have switched to another application, such as a web browser or a different application.

Finally, the AI engine 116 determines whether the user's focus is on the online learning platform 102 by comparing the identified web page or the application from the screenshots with the designated learning platform. If the screenshots show that the user's active window or application is the online learning platform 102, it indicates that the user is focused and engaged. Alternatively, if the screenshots reveal that the user has switched to a different application or browser, it signals that the user's attention is diverted away from the online learning platform 102.

In operation 210, a focus score calculator 124 calculates the focus score 128 of the user by utilizing the processed data. The focus score 128 is re-calculated every second to determine the user's current level of engagement while using the online learning platform 102.

The focus score calculator 124 integrated within the AI engine 116 is configured to calculate the focus score 128 by analyzing the user's engagement during an online learning session. The focus score calculator 124 calculates the user's focus score using the given formula:

$$‘ \% focus score = ( total time of the online learning session - total time when the user was not focusing ) / total time of the online learning session . ’$$

The focus score 128 is always calculated in terms of the percentage. This formula measures the proportion of time the user remains attentive on the learning content. The total time of the session refers to the entire duration the user spends on the online learning platform 102 during the time spent on the online learning session. The time when the user is not focusing is the cumulative period when the user is idle, distracted, or engaging with other applications. By subtracting the unfocused time from the total session time and dividing it by the total session time, the focus score calculator 124 generates a focus percentage. The focus score 128 reflects the user's overall engagement and helps in monitoring their attention levels throughout the online learning session.

Additionally, the AI engine 116 incorporates a window-switching cooldown mechanism to maintain user focus by detecting when the user attempts to exit or deviate from the focus mode before a predefined time. The focus mode is a predefined session designed to maximize user attention on the learning material for a predefined period. If the user tries to leave the focus mode before the predefined time, the AI engine 116 activates a window-switching cooldown mechanism which in turn activates a cooldown period. During this cooldown period, the user is temporarily prevented from switching tasks.

Further, the AI engine 116 presents a message to the user, explaining the negative impact of task-switching on learning outcomes and how it reduces focus and productivity. This message serves to educate the user on the importance of maintaining sustained attention during study sessions.

To make the cooldown period more transparent, a countdown timer is included that displays the remaining time of the cooldown period. The cooldown period is the time during which the user is not allowed to perform any task outside of the focus mode. For instance, if the cooldown timer is 10 seconds, then the user has to wait for 10 seconds until the timer shows 0. Then only the user can access the online learning session again.

The pseudocode describes a function called ‘calculate Focus Score’ that calculates the focus score 128 by utilizing the input data collected by the data collector 112. The ‘calculate Focus Score’ function first checks the presence of the user in front of the screen from the inputs from the webcam 104. The ‘calculate Focus Score’ function then checks the idleness of the user while using the online learning platform 102 by checking the inputs from the screen content 106. The ‘calculate Focus Score’ function then monitors the focus of the user during the online learning session by checking the inputs received from app usage 108. After that, the ‘calculate Focus Score’ function calculates the focus score 128 by analyzing the presence, idleness, and app focus of the user. After generating the focus score 128, the ‘calculate Focus Score’ function updates the focus score 128 every second. Then the ‘calculate Focus Score’ function returns the updated focus score 128 to the user on the user interface 132 integrated within the online learning platform 102.

In operation 212, a user interface 132 presents the calculated focus score 128 to the user in real-time, along with an issue count, current status, or ongoing issue related to the user's current level of engagement, visually color-coded feedback 130.

The user interface 132 is integrated into the online learning platform 102 and is configured to present the final result to the user. The final result includes the calculated focus score 128, the issue count, current status, or ongoing issue related to the user's current level of engagement, and visually color-coded feedback 130. This user interface 132 provides immediate feedback on the user's level of engagement during the online learning session.

The issue count represents the number of instances where the AI engine 116 has detected deviations or distractions in the user's behavior. These deviations could include actions such as becoming idle, switching to other applications, or moving away from the webcam 104. By presenting this information, the online learning platform 102 enables users to be aware of their engagement levels and the number of times they have been distracted during the online learning session, and encourages them to maintain focus throughout the online learning sessions. Each time the AI engine 116 identifies that the user is not fully engaged whether due to idleness, application switching, or absence, the issue count increases.

To enhance user understanding and immediate recognition of their engagement status, the online learning platform 102 employs visually color-coded feedback 130 by utilizing a feedback module 126. The color-coding scheme indicates two colors, namely, a green color signifies a focused state, indicating that the user is actively engaged with the online learning platform 102. On the other hand, a red color denotes an unfocused state, which can incorporate situations such as the user being away from the computer, idle without interacting with the content, using other applications, or browsing unrelated or non-educational web pages. This visual approach allows users to quickly assess their engagement level at a glance.

All these elements, the focus score 128, issue count, current status, and color-coded feedback 130 are cohesively displayed via the user interface 132 of the online learning platform 102. The real-time presentation of this information ensures that users receive immediate feedback on their actions, enabling them to adjust their behavior promptly wherever needed.

The issue count represents the number of instances where the AI engine 116 has detected deviations or distractions in the user's behavior. These deviations could include actions such as becoming idle, switching to other applications, or moving away from the webcam 104. By presenting this information, the online learning platform 102 enables users to be aware of their engagement levels and the number of times they have been distracted during the online learning session, and encourages them to maintain focus throughout the online learning sessions. Each time the AI engine 116 identifies that the user is not fully engaged whether due to idleness, application switching, or absence, the issue count increases.

To enhance user understanding and immediate recognition of their engagement status, the online learning platform 102 provides a visually color-coded feedback 130 by utilizing a feedback module 126. The color-coding scheme indicates two colors, namely, a green color signifies a focused state, indicating that the user is actively engaged on the online learning platform 102. On the other hand, a red color denotes an unfocused state, which indicate situations such as the user being away from the computer, idle without interacting with the content, using other applications, or browsing unrelated or non-educational web pages. This visual approach allows users to assess their engagement level at a quick glance.

All these elements, the focus score 128, issue count, current status, and color-coded feedback 130 are cohesively displayed via the user interface 132 of the online learning platform 102. The real-time presentation of this information ensures that users receive immediate feedback on their actions, enabling them to adjust their behavior promptly wherever needed.

The pseudo-code used in the real-time focus score calculation and visualization system is given below:

$$function calculateFocusScore ( ) :$$

$$presence = checkPresence ( webcamFeed )$$

$$idleness = checkIdleness ( screenCaptures )$$

$$appFocus = checkAppUsage ( appData )$$

$$focusScore = computeScore ( presence , idleness , appFocus )$$

$$updateFocusScoreWindow ( focusScore )$$

$$return focusScore$$

In the real-time focus score calculation and visualization system 100, the privacy of the user's input data is maintained. All data captured from the webcam 104, screen content 106, and app usage 108 is processed in compliance with data privacy regulations. Since data collector 112 captures input data from webcam 104 and records screen content 106, it is necessary to maintain data privacy.

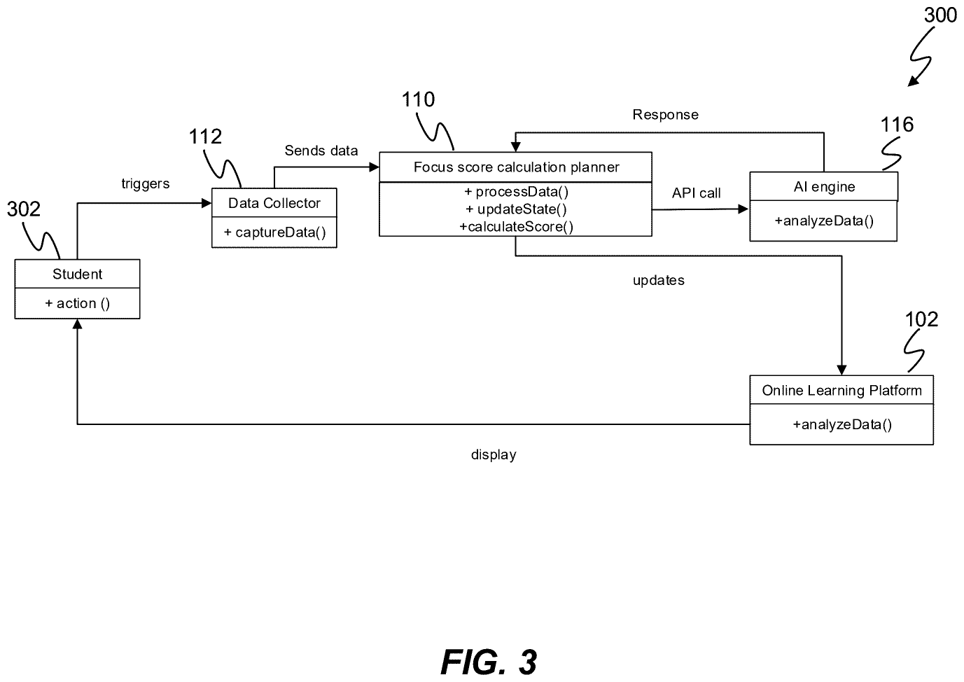

FIG. 3 depicts an exemplary focus score calculation process 300, which is an embodiment of the real-time focus score calculation and visualization process 200 of FIG. 2.

The focus score calculation process 300 illustrates the calculation of the focus score 128 of the user using the online learning platform 102. The focus score calculation process 300 starts when student 302 starts the online learning session while engaging with the online learning platform 102. This action triggers the data collector 112, which is responsible for capturing various types of input data related to the student's behavior and engagement using webcam 104, screen content 106, and app usage 108 data. The data collector 112 collects real-time input from multiple sources, such as screen activity, application usage, and possibly webcam data, and then sends the captured data to the focus score calculation planner 110.

The collected input data from the data collector 112 undergoes further processing by utilizing the focus score calculation planner 110. The focus score calculation planner 110 is responsible for processing the collected input data, and updating the user's current level of engagement.

The focus score calculation planner 110 an API (Application Programming Interface) call to the AI engine 116, which utilizes multiple machine learning algorithms to detect the current state of the user i.e., whether the user is present or absent in front of the webcam 104, idleness of the user, and whether the user is switching to another browser or application during the online learning session taking place at the online learning platform 102 by utilizing the presence detection algorithm 118, screen change detection algorithm 120, and app focus algorithm, respectively.

Based on the detection of these engagement statuses of the user, the focus score calculator 124 calculates the focus score 128 of the user. This focus score 128 represents the user's level of attention and interaction with the online learning platform 102. Once the analysis is complete, the AI engine 116 updates the focus score and presents the focus score 128 to the user via the user interface 132. The online learning platform 102 then displays the updated focus score 128, alongside other relevant feedback 130, directly to the student 302.

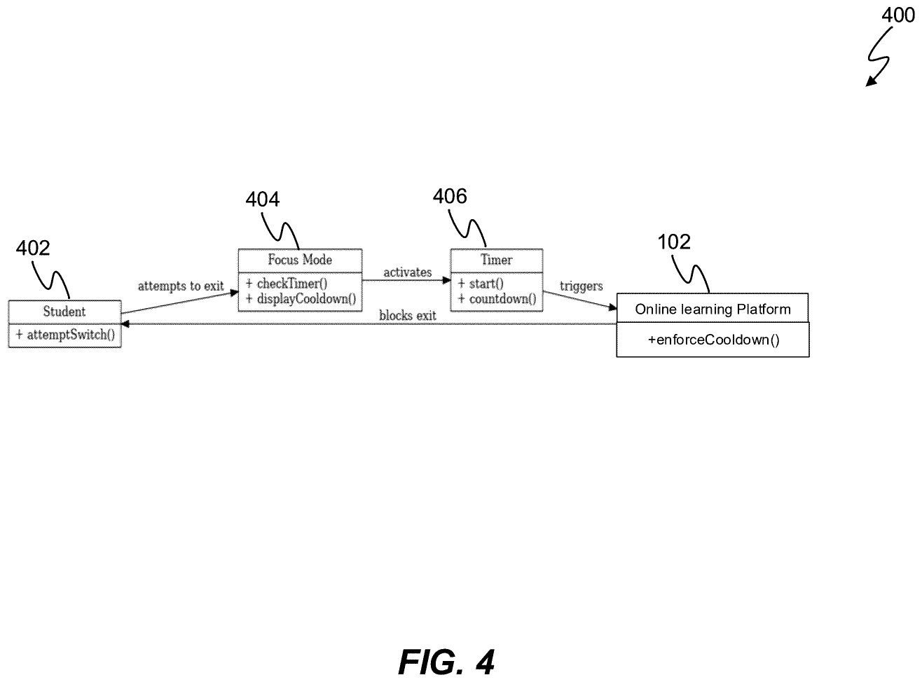

FIG. 4 depicts an exemplary windows switching cooldown process 400 when a user is working in focus mode on the online learning platform 102, which is an embodiment of the real-time focus score calculation and visualization process 200 of FIG. 2.

The windows switching cooldown process 400 illustrates how the online learning platform 102 allows student 402 to access the focus mode 404 during the online learning session. The windows switching cooldown process 400 further manages the situation when student 402 attempts to exit focus mode 404 by utilizing the windows switching cooldown mechanism. The windows switching cooldown mechanism gets activated as soon as the user exits the focus mode 404.

The windows switching cooldown process 400 begins with student 402 engaged in the online learning session on the online learning platform 102. If the student tries to exit focus mode 404, the AI engine 116 (not shown in the figure) gets an update that the student 402 is trying to exit or switch the focus mode 404. This leads to the activation of the windows switching cooldown mechanism, a feature within the online learning platform 102 designed to help student 402 concentrate and remain engaged during the online learning session.

Upon receiving the student's exit attempt, a cooldown timer 406 comes into action, which starts with a countdown of 10 seconds, where student 402 is provided a break of 10 seconds, and presented with some messages that explain the student 402 the drawbacks of switching the tasks in between the online learning sessions. The function of the focus mode 404 is to re-engage student 402 with the online learning platform 102 and prevent the immediate exit of student 402 from the online learning session by providing a cooldown period of 10 seconds, along with the message. This message serves as a visual indicator that the student 402 must remain in focus mode 404 until the timer 406 of the tasks given during the online learning session is completed.

The timer 406 manages the countdown for the cooldown period. The focus mode 404 triggers the timer 406 and activates the cooldown mechanism. The timer 406 keeps on counting and as soon the timer 406 reaches the zero value, the online learning session is again activated. The online learning platform 102 enforces the cooldown mechanism as the timer 406 stops and provides student 402 access to the focus mode 404 of the online learning session.

This ensures that student 402 remains in focus mode 404 by blocking any further attempts to exit until the cooldown timer finishes. This mechanism ensures that student 402 is encouraged to remain focused and follow the time limits allotted to each online learning session, thereby minimizing distractions and promoting better learning outcomes. This cooldown serves as a psychological deterrent, encouraging the user to reconsider their decision and maintain focus on the learning task at hand. If the user decides to stay in focus mode, he/she can easily cancel the switch and continue the online learning session uninterrupted.

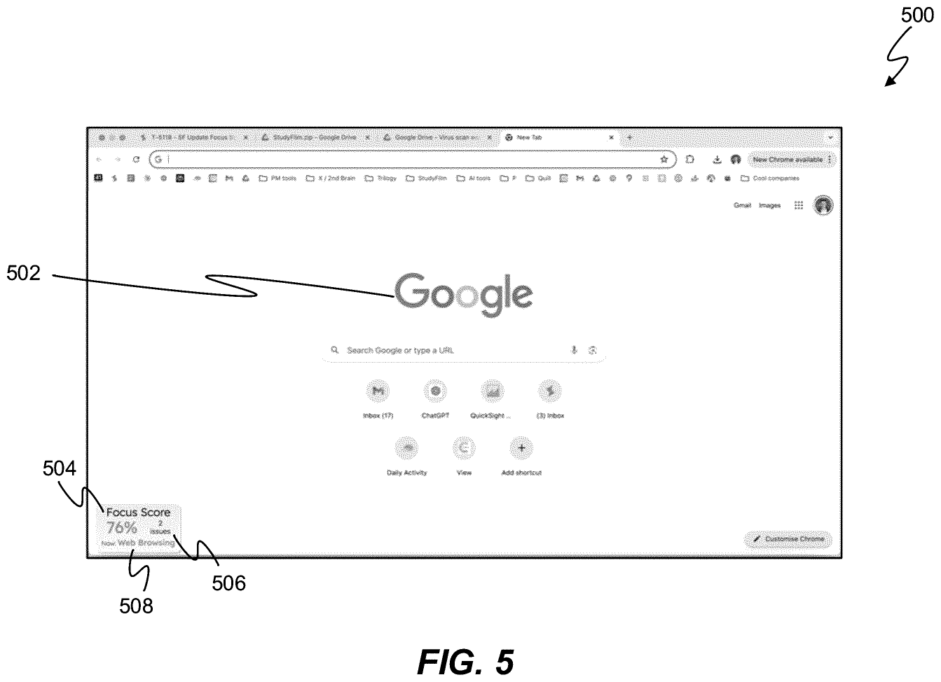

FIG. 5 depicts an exemplary user interface 502 disclosing the use of a browser 504 other than the online learning platform 102 during the online learning session for which the real-time focus score calculation and visualization system 100 calculates and presents the focus score 128 to the user.

The user interface 500 shows that the user is using the browser 502 other than the online learning platform 102 in between the online learning sessions. For instance, in the case of the present example, the browser 502 browsed by the user is ‘Google’. The user here, besides attending the online learning sessions, is browsing the Google browser 502, which shows that the user has exited or switched from the focus mode. During the focus mode, the user is provided with a predefined period, say 30 minutes, to finish a task. If the user distracts or disengages in between that time, the user is considered to have exited or switched the focus mode.

Based on the switching or exit of the user from the focus mode, the focus score 504 keeps on changing. The focus score calculator 124 calculates the focus score 504 based on the switching or exit of the user from the focus mode, by utilizing the number of times the user is distracted or disengaged during the online learning session. Number of issues 506 represent the count of events when the user disengages or distracts from the online learning session.

The focus score 504 of the user in the given example is 76%, which depicts that the focus score 504 is decreased due to the disengagement of the user from the online learning session. This is the current focus score 504 of the user and keeps on updating in real-time. For instance, if the user again starts using the online learning platform 102, the focus score 504 of the user will increase.

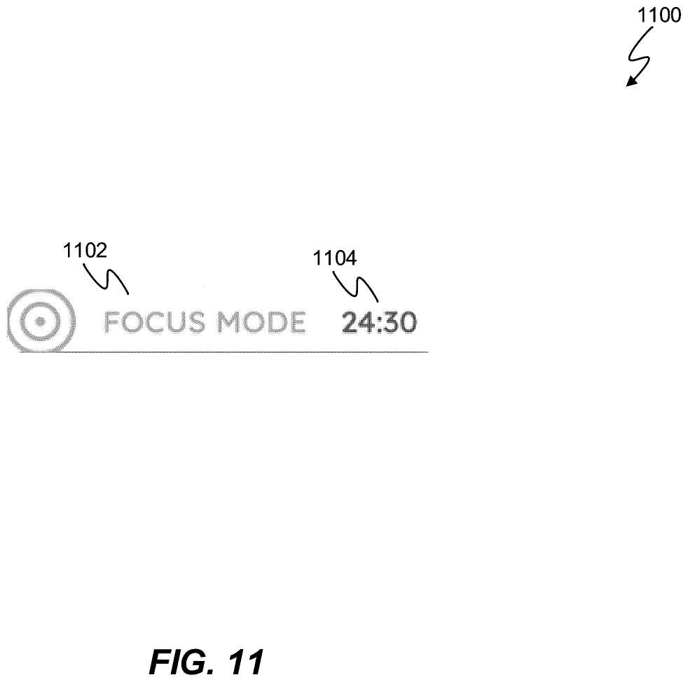

Further, the reason 508 for which the user is distracted is also indicated via the user interface 500. The AI engine 116 identifies the reason 508 using multiple machine learning algorithms. For instance, the reason 508 depicted in the present example is ‘Web Browsing’, which is determined by utilizing the screen change detection algorithm 120. The screen change detection algorithm 120 identifies the change in the user's screen by comparing the frames captured every second. Whenever the user switches from the online learning session, the screen change detection algorithm 120 detects the changes in the content of the screen and activates the cooldown timer, which is explained in detail in FIGS. 11-13.

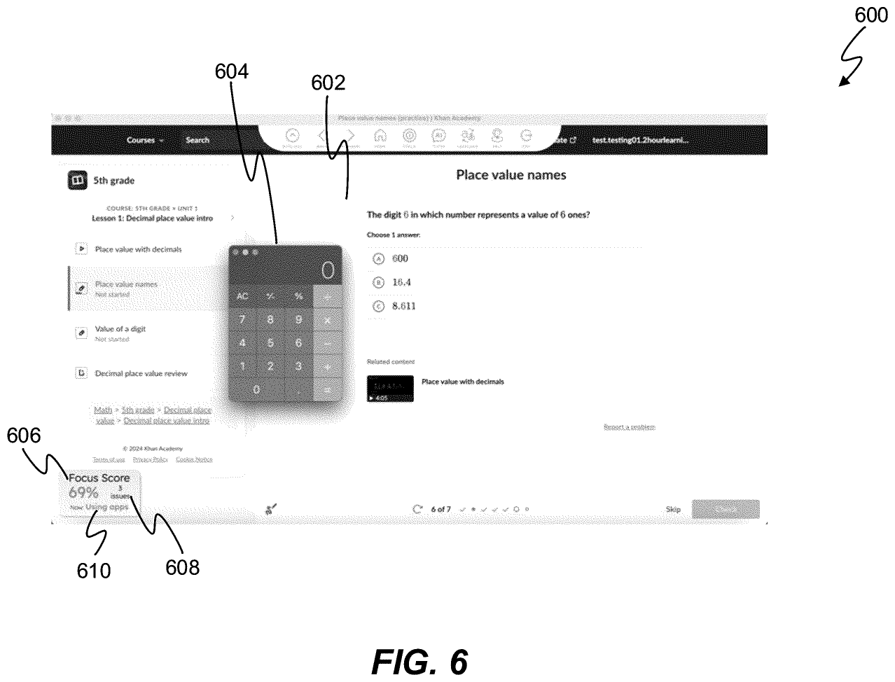

FIG. 6 depicts an exemplary user interface disclosing the use of other applications during the online learning session for which the real-time focus score calculation and visualization system calculates and presents the focus score to the user.

The user interface 600 shows that the user is using an app 604 other than the online learning platform 602 during the online learning session. More specifically, in this example, the user is using the calculator app 604 while attending the online learning session, which indicates that the user has exited or switched from the focus mode. In this session, the user is provided with a set of questions that the user should attempt to finish in a predefined amount of time. During the focus mode, the user is provided with a predefined period, say 30 minutes, to finish a task. If the user distracts or disengages during that time, the user is considered to have exited the focus mode.

The focus score 606 of the user in the given example is 69%, which depicts that the focus score 604 is decreased due to the disengagement of the user from the online learning session. The focus score 606 keeps on updating in real-time or at a predefined interval. For instance, if the user again starts using the online learning platform 602, the focus score 604 of the user will increase. Each time the user moves away from the online learning session, the platform counts the same as an issue. Therefore, if the user has moved away 3 times from the online learning platform during the session, the platform will depict the same as 3 issues 608.

Further, the user interface 600 shows a reason 610 for which the user is distracted from the platform during the session The AI engine 116 identifies the reason 610 using multiple machine learning algorithms. For instance, the reason 610 identified in the present example is ‘Using apps’, which is determined by utilizing the app focus algorithm 122. The app focus algorithm 122 identifies whether the user is using an app or browsing a web page while away from the online learning platform 602. Whenever the user switches from the online learning session, the app focus algorithm 122 detects the app usage and activates the cooldown timer, which is explained in detail in FIGS. 11-13.

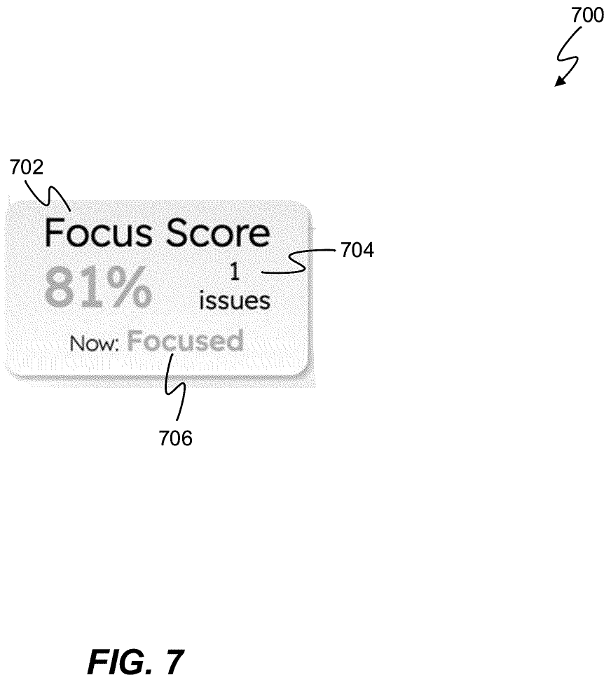

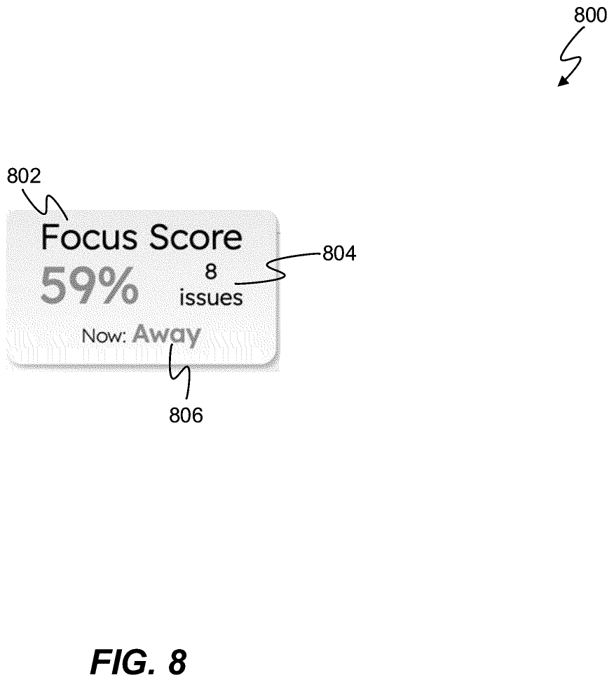

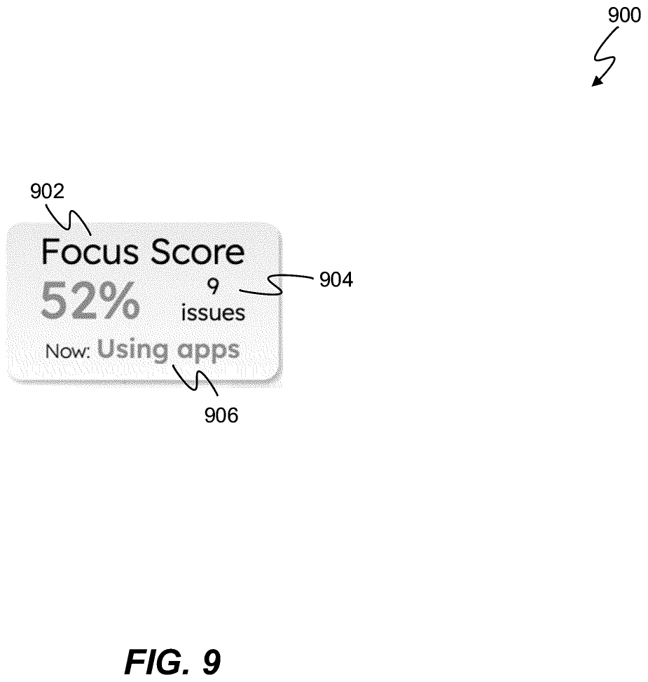

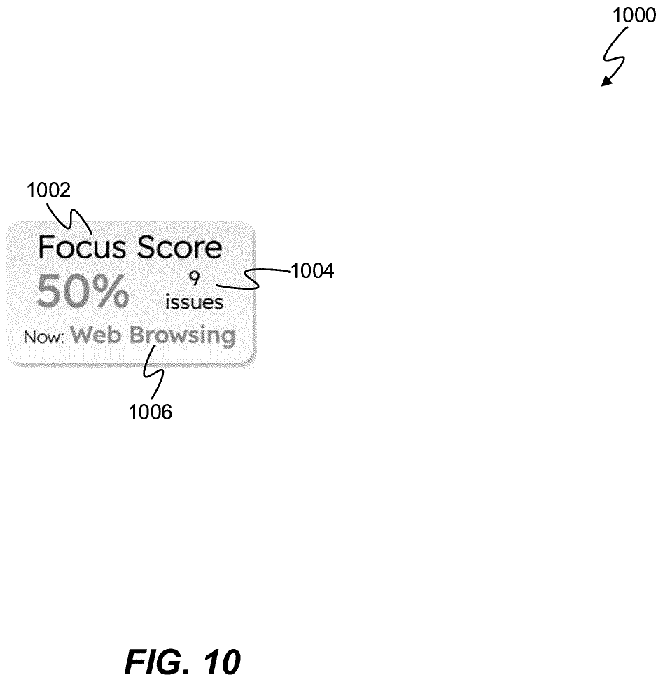

FIGS. 7-10 depict exemplary user interfaces disclosing the focus score of the user along with the corresponding issue.

The user interface 700 presents a high focus score 702 of 81% as the user is focusing in the session while being on the online learning platform 102. The focus score 702 of the user in the given example is 81%, which depicts that the focus score 702 is increased due to the continuous engagement of the user during the online learning session. This is the current focus score 702 of the user which will keep on updating at a predefined interval. For instance, if the user starts using another app besides the online learning platform 102, the focus score 702 of the user will decrease. The number of times the user distracts or disengages from the online learning session depicts the number of issues 704.

The reason 706 due to which the focus score 702 of the user is high is also reflected on the user interface 700. For instance, the reason 706 shown in the present example is ‘Focused’.

The user interface 800 shows a low focus score due to the absence of the user in front of the webcam 104. The focus score 802 of the user in the given example is 59%, which depicts that the focus score 802 is decreased due to the disengagement of the user from the online learning session. Further, the user is disengaged from the online learning session 8 times, which is indicated as 8 issues 804. The reason 806 for user disengagement in this case is ‘Away’, which is determined by utilizing the presence detection algorithm 118. The presence detection algorithm 118 identifies whether the user is present in front of the screen or not.

The user interface 900 depicts a further decreased focus score 902 of 52%. Here, the user has disengaged from the session for 9 times, which is indicated as ‘9 issues’ 904 and the reason 906 for this disengagement is ‘Using apps’, which is determined by utilizing the app focus algorithm 122. The app focus algorithm 122 identifies whether the user is using an app or browsing a web page other than the online learning platform 102. Whenever the user switches from the online learning session, the app focus algorithm 122 detects the app usage and activates the cooldown timer.

Further, the user interface 1000 shows a focus score 1002 of 50%, which indicates that the user is progressively disengaging with the online learning platform 102. Therefore, the issues 1004 are increased to 9 and here the reason for disengagement is ‘Web browsing’, which indicates that the user disengaged from the session and is browsing the web while the session is in progress.

FIG. 11 depicts an exemplary user interface 1100 showing a focus timer 1104 that gets activated when the user enters focus mode 1102.

The focus timer 1104 in the given example is set at 24:30, which indicates that the user has spent ˜24 minutes and 30 seconds on the online learning platform 102. The focus mode 1102 allows the user to self-assess his/her focus period during the online learning session. The focus timer 1104 starts as soon the user enters the focus mode 1102 during the online learning session. The user has to remain focused during the focus mode 1102, and if the user switches or exits from the focus mode 1102, the window switching cooldown mechanism activates.

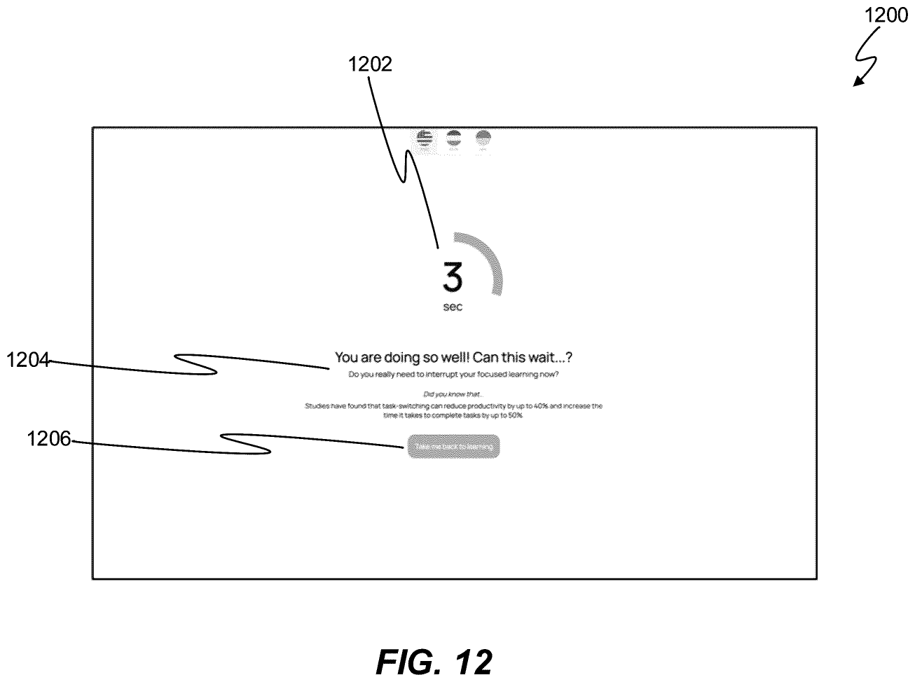

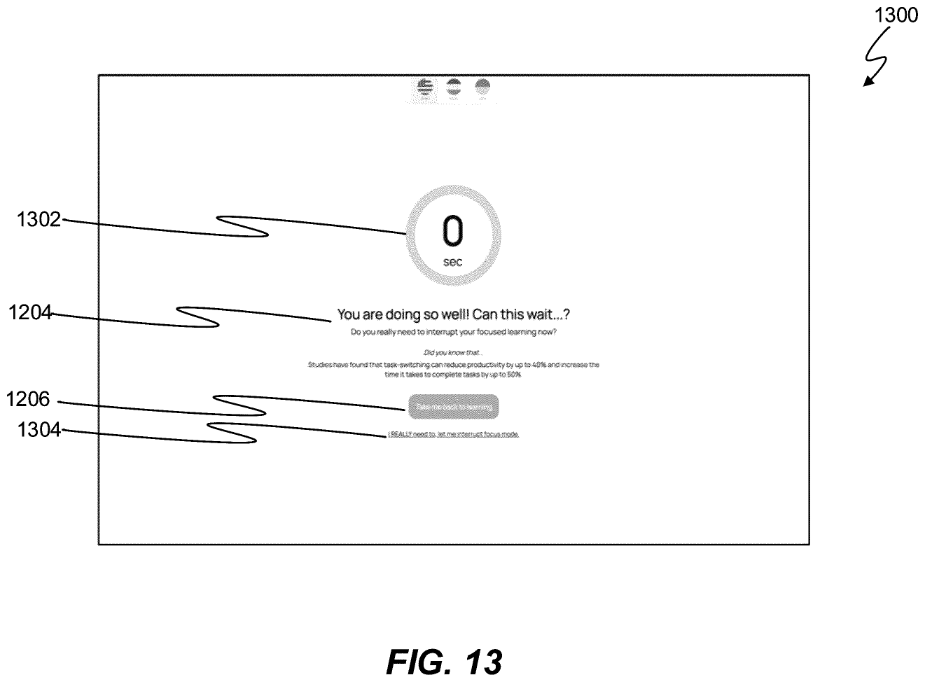

FIGS. 12 and 13 depict exemplary user interfaces showing the cooldown timer along with a message that educates the user about the negative impacts of switching tasks during the online learning sessions.

The user interface 1200 discloses the activation of the cooldown period as soon as the user switches or exits the focus mode 1102. The cooldown timer 1202 gets activated during the windows cooldown switching mechanism, say for 10 seconds, as shown in FIG. 12. Till the cooldown timer 1202 turns to 0, the user is not allowed to switch from that given user interface 1200, which means that the user has to stay on that particular page for 10 seconds, where a message 1204 is provided to the user, explaining the drawbacks of switching the tasks in between the online learning session. The immediate and real-time message 1204 makes the user more likely to reconsider their decision of switching or exiting from the online learning platform 102 to another app or browser and stay focused.

For instance, the message 1204 may include ‘You are doing so well!! Can this wait?? Do you really need to interrupt your focused learning now?? Did you know that. . . . Studies have found that task-switching has reduced productivity by up to 40% and increases the time it takes to complete the task by up to 50%.’ The user is presented with the message 1204 which motivates the user not to switch between the tasks during the online learning session.

Further, the user can click on the tab ‘Take me back to learning’ 1206 as soon as the cooldown timer 1202 stops and can again get access to the focus mode 1102.

In the user interface 1300, cooldown timer 1302 is displaying 0 seconds, which means that the cooldown period has resolved. Now the user can access the focus mode 1102 by clicking on the tab ‘Take me back to learning’ 1206. Further, the user can click on the tab ‘I really need to let me interrupt the focus mode’ 1304, if the user does not want to access the online learning session again. For instance, there may be situations like some family emergency, some health issue with the user, and so on, then at that time the user can click on the tab ‘I really need to let me interrupt the focus mode’ 1304 to exit the online learning session. In at least one embodiment, the user exits the focus mode or the online learning session after clicking on the tab 1304 shown in FIG. 13 as “I really need to let me interrupt the focus mode.”

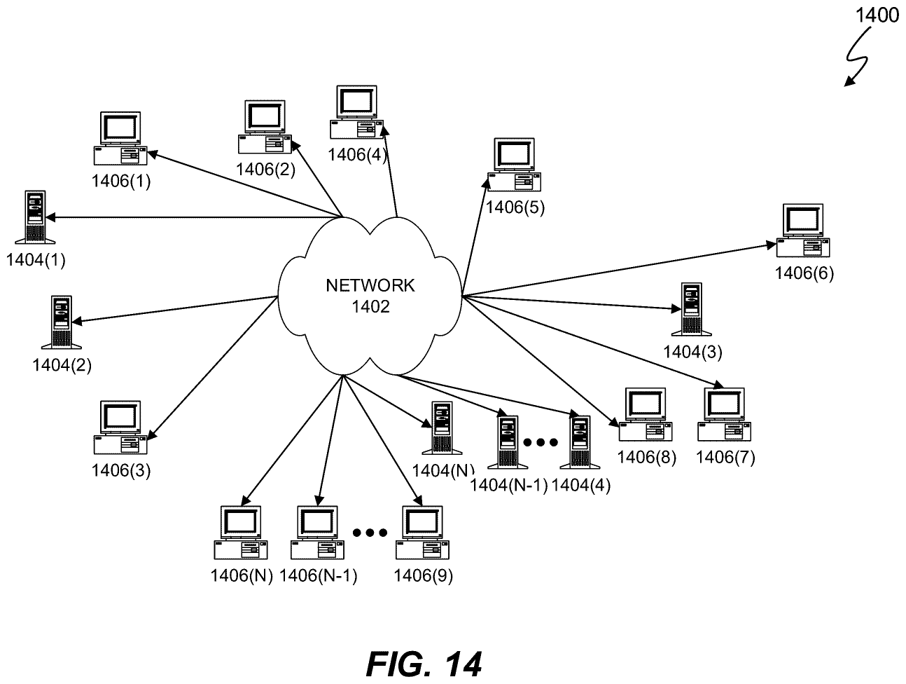

FIG. 14 is a block diagram illustrating a network environment in which a real-time focus score calculation and visualization system 100 and the process 200 may be practiced. Network 1402 (e.g. a private wide area network (WAN) or the Internet) includes a number of networked server computer systems 1404(1)-(N) that are accessible by client computer systems 1406(1)-(N), where N is the number of server computer systems connected to the network. Communication between client computer systems 1406(1)-(N) and server computer systems 1404(1)-(N) typically occurs over a network, such as a public switched telephone network over asynchronous digital subscriber line (ADSL) telephone lines or high-bandwidth trunks, for example communications channels providing T1 or OC3 service. Client computer systems 1406(1)-(N) typically access server computer systems 1404(1)-(N) through a service provider, such as an internet service provider (“ISP”) by executing application specific software, commonly referred to as a browser, on one of client computer systems 1406(1)-(N).

Client computer systems 1406(1)-(N) and/or server computer systems 1404(1)-(N) are specialized computer programmed to improve conventional computer systems to implement and utilize the real-time focus score calculation and visualization system 100 and the process 200. The type of computer system that can be specially programmed to implement and utilize the real-time focus score calculation and visualization system 100 and the process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time focus score calculation and visualization system 100 and the process 200 can be implemented using code stored in a tangible, non-transient computer readable medium and executed by one or more processors. In at least one embodiment, the real-time focus score calculation and visualization system 100 and the process 200 can be implemented completely in hardware using, for example, logic circuits and other circuits including field programmable gate arrays.

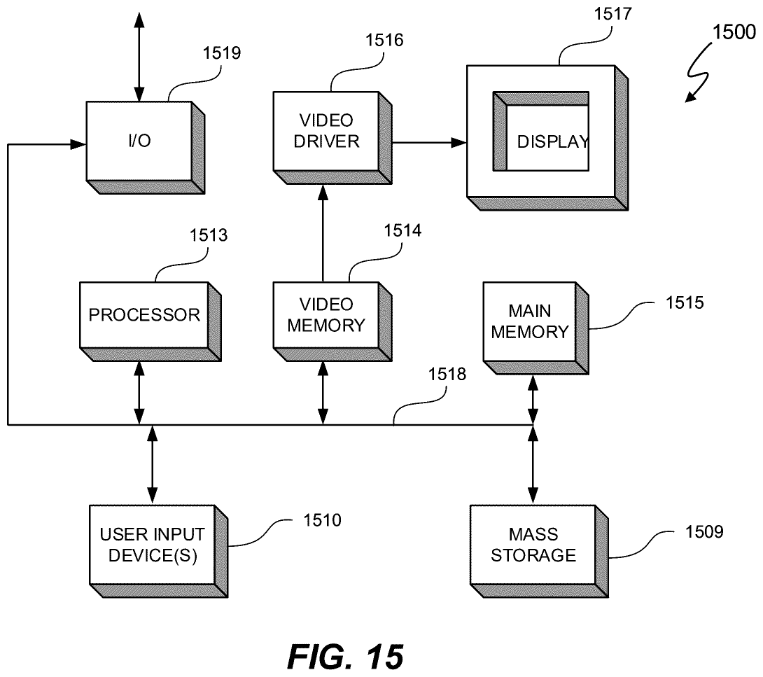

Embodiments of the real-time focus score calculation and visualization system 100 and the process 200 can be implemented on a computer system such as a special-purpose, special-programmed computer 1500 illustrated in FIG. 15. Input user device(s) 1510, such as a keyboard and/or mouse, are coupled to a bi-directional system bus 1518. The input user device(s) 1510 are for introducing user input to the computer system and communicating that user input to processor 1513. The computer system of FIG. 15 generally also includes a non-transitory video memory 1514, non-transitory main memory 1515, and non-transitory mass storage 1509, all coupled to bi-directional system bus 1518 along with input user device(s) 1510 and processor 1513. The mass storage 1509 may include both fixed and removable media, such as a hard drive, one or more CDs or DVDs, solid state memory including flash memory, and other available mass storage technology. Bus 1518 may contain, for example, 32 of 64 address lines for addressing video memory 1514 or main memory 1515. The system bus 1518 also includes, for example, an n-bit data bus for transferring DATA between and among the components, such as CPU 1509, main memory 1515, video memory 1514, and mass storage 1509, where “n” is, for example, 32 or 64. Alternatively, multiplex data/address lines may be used instead of separate data and address lines.

I/O device(s) 1519 may provide connections to peripheral devices, such as a printer, and may also provide a direct connection to a remote server computer systems via a telephone link or to the Internet via an ISP. I/O device(s) 1519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer readable medium such as flash memory, optical memory, magnetic memory, compact disks, digital versatile disks, and any other type of memory. The computer program is loaded from a memory, such as mass storage 1509, into main memory 1515 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1513, in one embodiment, is a microprocessor manufactured by Motorola Inc. of Illinois, Intel Corporation of California, or Advanced Micro Devices of California. However, any other suitable single or multiple microprocessors or microcomputers may be utilized. The special-programmed system 1500 also includes natural language processor 1520 and one or more suitable language models 1522 to process the input data. Main memory 1515 is comprised of dynamic random access memory (DRAM). Video memory 1514 is a dual-ported video random access memory. One port of the video memory 1514 is coupled to the video amplifier 1516. The video amplifier 1516 is used to drive the display 1517. Video amplifier 1516 is well-known in the art and may be implemented by any suitable means. This circuitry converts pixel DATA stored in video memory 1514 to a raster signal suitable for use by display 1517. Display 1517 is a type of monitor suitable for displaying graphic images.

The computer system described above is for purposes of example only. The real-time focus score calculation and visualization system 100 and the process 200 may be implemented in any type of computer system or programming or processing environment. It is contemplated that the real-time focus score calculation and visualization system 100 and the process 200 might be run on a stand-alone computer system, such as the one described above. The real-time focus score calculation and visualization system 100 and the process 200 might also be run from a server computer systems system that can be accessed by a plurality of client computer systems interconnected over an intranet network. Finally, the real-time focus score calculation and visualization system 100 and the process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of enhancing user engagement by calculating and visualizing a focus score of a user using an online learning platform, the method comprises:
executing code using one or more processors of a computer system to cause the computer system to perform operations comprising:
capturing input data from a plurality of sources, wherein the plurality of sources include webcam, screen content, and application usage;
processing the captured input data by providing it to an AI engine that utilizes machine learning algorithms to:
determine if the user is physically present in front of the webcam or not by utilizing a presence detection algorithm;
identify idleness of the user by detecting changes in the screen content by utilizing a screen change detection algorithm;
identify whether the focus of the user is on the online learning application, or some other browser page or application by utilizing an app focus algorithm;
calculating the focus score of the user by utilizing the processed data, wherein the focus score is re-calculated every second to determine the user's current level of engagement while using the online learning platform;
presenting the calculated focus score to the user in real-time, along with an issue count, current status, or ongoing issue related to the user's current level of engagement, visually color-coded feedback.

2. The method of claim 1 wherein the plurality of input data captured from webcam, screen content, and application usage are captured on a per-second basis in real-time.

3. The method of claim 1 wherein the input data captured using the webcam, screen content, and application usage includes user's presence detection data, idleness detection data, and application switching data respectively.

4. The method of claim 1 wherein the user's presence detection data, idleness detection data, and application switching data further includes a time duration when the user is not focusing on the online learning platform, or switching to other applications or browsers while using the online learning platform.

5. The method of claim 4 wherein the time duration is a total unfocused time of the user while using the online learning platform.

6. The method of claim 1 wherein along with the captured input data, a prompt generated by a prompt engineer is also provided to the AI engine.

7. The method of claim 1 wherein the AI engine processes the captured input data and generates a response in a JSON format, which includes the result to be either true or false.

8. The method of claim 1 wherein the determination of the physical presence of the user by analyzing the captured frames from the webcam further comprises:
capturing frames from the webcam at a regular interval of one frame per second;
utilizing the presence detection algorithm to analyze the frames for identifying facial features, body movement, and other features to indicate the user's presence; and
determining the absence of the user if the features indicating the user's presence are not detected, wherein the absence of the user indicates that the user is not present in front of the webcam and is not attending the given online learning session.

9. The method of claim 1 wherein identifying the idleness of the user during the online learning session further comprises:
capturing screenshots of the screen content within every pre-defined interval of time;
utilizing the screen change detection algorithm to compare consecutive screenshots of the screen content to detect changes, including open window, cursor movement, and current content of the online learning session; and
analyzing the degree of changes between the consecutive screenshots of the screen content, wherein if the degree of changes is below a pre-defined threshold value then the user is detected as idle.

10. The method of claim 1 wherein identifying the focus of the user during the online learning session based on switching applications further comprises:
capturing screenshots of the screen content within every pre-defined interval of time;
utilizing the app focus algorithm to identify the current webpage or application browsed by the user; and
determining whether the user's focus is on the online learning platform or not, wherein the user's focus depends on the web page or application that the user is currently using.

11. The method of claim 1 further comprises:
detecting when the user attempts to exit or deviate from a focus mode before a predefined time, wherein the focus mode is accessed by the user during the online learning session;
introducing a cooldown period by utilizing a deterrent mechanism when the user exits the focus mode; and
presenting a message to the user explaining the negative impact of task switching on focus and learning outcomes during the online learning session.

12. The method of claim 1 further comprises:
a countdown timer that visually displays the remaining time of the cooldown period, wherein the cooldown period is the time at which the user is not allowed to perform any task.

13. The method of claim 1 wherein the issue count indicates the number of instances where the AI engine detects deviation or distraction in the behavior of the user during an online learning session.

14. The method of claim 1 wherein the visually color-coded feedback, which includes a green color for the focused state, and a red color for the unfocused state, including away, idle, using apps, or using the browser.

15. A system to enhance user engagement by calculating and visualizing a focus score of a user using an online learning platform comprises:
one or more processors of a computer system;
a memory, coupled to the one or more processors, that stores code and execution of the code by the one or more processors causes the computer system to perform operations comprising:
capturing input data from a plurality of sources using a data collector, wherein the plurality of sources include webcam, screen content, and application usage;
processing the captured input data using an analyzer and providing it to an AI engine that utilizes machine learning algorithms to:
determine if the user is physically present in front of the webcam or not by utilizing a presence detection algorithm;
identify idleness of the user by detecting changes in the screen content by utilizing a screen change detection algorithm; and
identify whether the focus of the user is on the online learning application, or some other browser page or application by utilizing an app focus algorithm;
calculating the focus score of the user by utilizing the processed data using a focus score calculator, wherein the focus score is re-calculated every second to determine the user's current level of engagement while using the online learning platform;
presenting the calculated focus score to the user in real-time, along with an issue count, current status, or ongoing issue related to the user's current level of engagement, visually color-coded feedback.

16. The system of claim 15 wherein the focus score along with the issue count, current status, or ongoing issue related to the user's current level of engagement, visually color-coded feedback is displayed to the user on a user interface of the online learning platform.

17. The system of claim 15 wherein the focus score calculator calculates the focus score of the user by utilizing the formula:
percentage focus score=(total time of the online learning session − total time when the user was not focusing)/total time of the online learning session.

18. The system of claim 15 further comprises:
a cooldown mechanism that is activated when the user attempts to switch away from the online learning platform, including a countdown timer and educational messages designed to discourage task-switching, thereby enhancing the user's focus and engagement.

19. The system of claim 15 wherein the privacy of the user's input data is maintained and all data captured from the webcam, screen content, and application usage is processed in compliance with data privacy regulations.
